(19) United States
(12) Patent Application Publication
(10) Pub. No.: US 2003/0133363 A1
(43) Pub. Date: Jul. 17, 2003

(54) Clock with pressure sensitive signal source

(76) Inventor: David Kwok, Hong Kong (HK)

Correspondence Address: SONNENSCHEIN NATH & ROSENTHAL, P.O. BOX 061080, WACKER DRIVE STATION, CHICAGO, IL, 60606-1080, US

(21) Appl. No.: 10/044,030

(22) Filed: Jan. 11, 2002

(51) Int. Cl. G04B 23/00

(52) U.S. Cl. 368/262

(57) ABSTRACT

An alarm clock device activated by release of pressure. A base member has an external side, an internal side and an aperture with at least one movable member and at least one fixed member positioned to contact each other. At least one bias member is connected to the at least one movable member to bias the movable member in contact with the fixed member to send a signal. A button member is positioned within the aperture wherein the button member reciprocates to break contact between the at least one movable member and the at least one fixed member to disengage the signal. A signal circuit is in communication with the movable member and the fixed member.

### BACKGROUND OF THE INVENTION

The present invention relates to an alarm clock. In particular, the invention relates to an alarm clock that activates a signal when the alarm clock is elevated off a surface.

In today's fast paced society, many people require sufficient sleep while still waking at an early time in the morning. As such, sleeping and waking up in a comfortable environment is extremely important. Alarm clocks, currently available, present different mechanisms to illuminate the time and to wake the user. Commonly, the user will wake to an alarm and try to locate a specific button such as light button. Additionally, many users will also try to find a snooze button upon waking to activate the snooze function.

Current alarm clocks are being made smaller with corresponding smaller operating buttons. A problem with current alarm clocks, however, is being able to accurately and comfortably locate the correct operating button to turn on the light or turn off the alarm or activate the snooze process. Additionally, another problem is being able to quickly locate the correct button in the dark to turn on the light. Because of the small scale of the clocks, the operating buttons are closely positioned resulting in the user pressing the incorrect operating button. Further, alarm clocks which remain illuminated during the sleep period create too much light for some users resulting in an uncomfortable sleep period.

A need, therefore, exists to easily and comfortably allow the user to activate a light on the alarm clock. The solution, however, must be capable of allowing the user to easily activate the light in the dark. Further, the solution must be capable of eliminating small inconvenient buttons which are difficult to find in the dark. A need also exists to allow the user to quickly activate a snooze process on the alarm clock. The solution must also eliminate the small and inconvenient snooze buttons. Further, the solution must be capable of allowing the user to activate the snooze process simultaneously while activating the light with one motion by the user.

A need further exists to comfortably allow the user to activate a light without activating a snooze process. The solution, however, must be capable of allowing the user to easily activate the light in the dark. Further, the solution must be capable of eliminating the small inconvenient operating buttons while activating the light.

Alarm clocks currently available often use a button or buttons which must be depressed to turn on the light and activate the snooze. As such, these alarm clocks fail to meet the current need since the user is required to find a specific button or buttons in the dark to activate the light and the snooze process. Accordingly, the user may inadvertently depress a radio button or an alarm button resulting in more noise that may disrupt the user's waking process. Further, the user may inadvertently depress a time button to incorrectly set the clock time or alarm time resulting in the user oversleeping.

### SUMMARY OF THE INVENTION

The present invention provides for an alarm clock, in particular, an alarm clock that activates a signal when the alarm clock is elevated from a surface.

To that end, the invention provides an alarm clock that comfortably and easily allows a user to illuminate the alarm clock and activate the snooze process in one motion by the user. The present invention also allows a user to illuminate the alarm clock without activating the snooze function.

Described in the accompanying drawings and following text is an alarm clock device that can send a signal when elevated off a surface. This configuration leads to improved sleep periods. Thus, the invention disclosed herein provides alarm clock device which overcomes many of the inadequacies of alarm clocks known in the art.

In an embodiment, the device comprises a base member having an external side, an internal side and an aperture. At least one movable member and at least one fixed member are positioned to contact each other wherein at least one bias member connects to the at least one movable member to bias the movable member beyond the plane of the base and in contact with the fixed member to send a signal.

In an embodiment, a button member is positioned to break contact between the at least one movable member and the at least one fixed member to disengage the signal. Additionally, a signal circuit communicates with the movable member and the fixed member wherein the signal circuit operates at least one of a light, alarm and snooze. In an embodiment, the signal circuit includes a light circuit, an alarm circuit and a snooze circuit.

In an embodiment, the device comprises a clock signal device for activating a signal by release of pressure over a period of time comprising a base member having an external side, an internal side and an aperture extending between the external side and the internal side. A movable member is positioned to contact a fixed member.

Additionally, a bias member connects to the movable member to bias the movable member in contact with the fixed member. Further, a signal circuit communicates with the movable member and the fixed member wherein the signal circuit sends at least one signal in response to the contact between the movable member and the fixed member.

In an embodiment, the signal circuit sends a light signal in response to the contact between the movable member and the fixed member.

In an embodiment, the signal circuit sends a snooze signal in response to the contact between the movable member and the fixed member.

In an embodiment, the button member reciprocates from an open position to a closed position.

In an embodiment, the device comprises an alarm clock for activating a signal when the alarm clock is elevated off a surface comprising an enclosure having an external side, an internal side and a base normally in contact with the surface. Additionally, a button member extends from the surface to the internal side with the button member being normally in contact with the surface. Further, a bias member biases the button member partially out of the enclosure and beyond the plane of the base when the base is elevated off the surface.

The present invention also provides a method of using an alarm clock which activates at least one signal when the alarm clock is elevated off a surface comprising pressuring a button member in an open position. Next, the method provides elevating the alarm clock off the surface. Further, the method provides biasing a movable member in contact with a fixed member while biasing the button member to a closed position. Next, at least one signal is sent by the contact between movable member and the fixed member.

In an embodiment, the method provides lowering the alarm clock back on the surface and pressuring the button member back to the open position.

An advantage of the present invention is to allow the user to easily activate at least one signal in the dark.

Another advantage of the present invention is to allow the user to activate a light source by simply lifting the clock.

Another advantage of the present invention is to allow the user to activate a snooze function by simply lifting the clock.

### BRIEF DESCRIPTION OF THE DRAWINGS

FIG. 1 is a front elevational view of a clock embodying the principles of the present invention.

FIG. 2 is a side sectional view of the clock embodying the principles of the present invention.

FIG. 3 is a partial sectional view of a component of the present invention with the clock resting on a surface.

FIG. 4 is a partial sectional view of the component of FIG. 2 with the clock elevated above the surface.

FIG. 5 is a schematic circuit diagram embodying the principles of the present invention.

### DETAILED DESCRIPTION OF THE PREFERRED EMBODIMENTS

As discussed above, the present invention provides structures and other accommodations for an alarm clock to activate a signal when the alarm clock is elevated from a surface. The present invention comfortably and easily allows a user to illuminate the alarm clock and activate the snooze process in one motion by the user. The present invention also allows a user to illuminate the alarm clock without activating the snooze function.

The apparatus of this invention includes certain conventional components, including quartz movement and timing circuits, the details of which, although not fully illustrated or described, will be apparent to those having skill in the art and an understanding of the necessary function of such components. Additionally, the present invention accommodates a full range of timing functions such as, but not limited to, indicia display, alarm and radio functions.

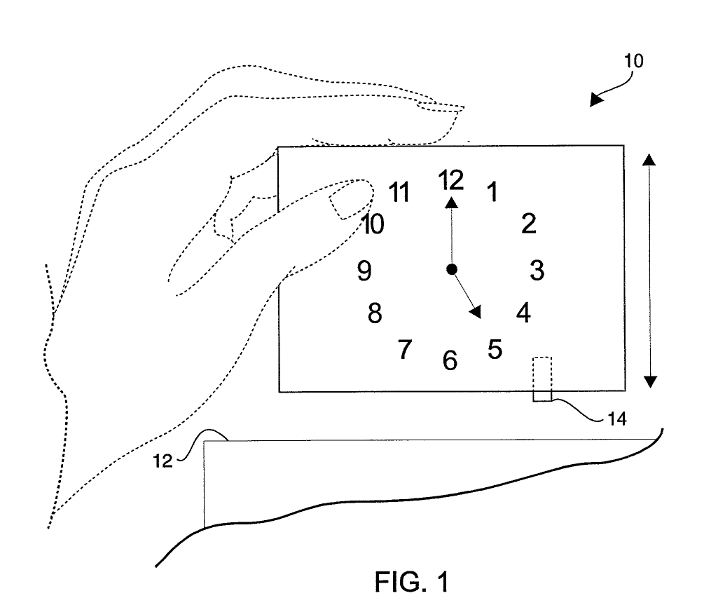

FIG. 1 illustrates a front elevational view of an exemplary clock 10 which activates a signal when elevated off a surface 12. The clock 10 typically rests on the surface 12 such as a tabletop or desktop wherein upon elevation, as shown in FIG. 1, a button member 14 extends out of the clock 10.

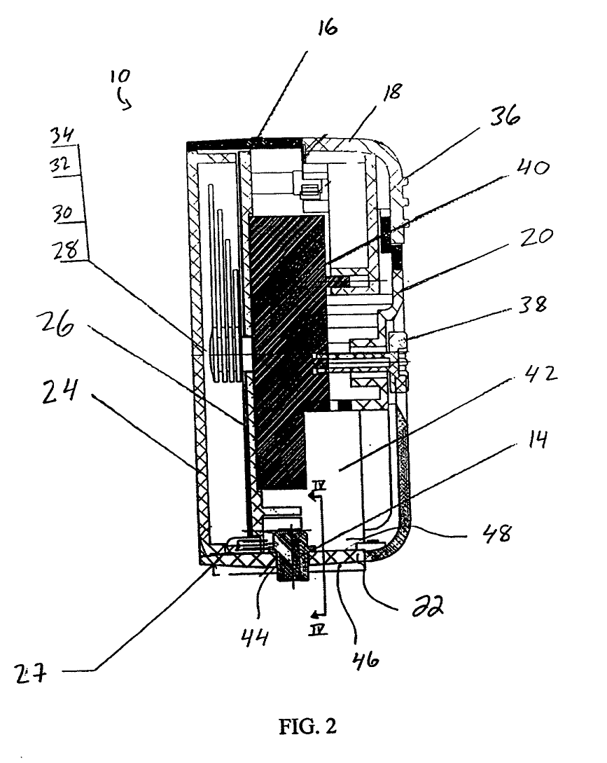

Turning to FIG. 2, the clock 10, illustrated in cross section, comprises an enclosure 16 with a top 18, back 20 and base 22 wherein the enclosure 16 can incorporate any material suitable for the application such as injection molded polymeric material, metal and wood. Additionally, the enclosure 16 may be a single or multi-part assembly having a painted, plated, stamped or molded finish.

The clock further comprises a lens 24, made from a variety of materials such as glass, molded plastics or cast materials, which protects a dial 26. Typically, the lens 24 is clear but may be tinted. The dial 26, in turn, may be made from paper, plastic and metal and has time indicating graphics such as indicia or figures applied to the front surface by printing, stamping or adhesive. A light source 27, such as an incandescent bulb, is positioned to illuminate the graphics on the dial 26. The dial 26 may also include a light emitting diode to display the necessary indicia or information.

The dial 26 connects to an alarm hand 28, an hour hand 30, a minute hand 32 and a second hand 34 as shown in FIG. 2. The alarm hand 28, hour hand 30, minute hand 32 and second hand 34 perform the normal functions of indicating time by the relationship to the graphics of the dial 26. The hands may be made from a variety of materials and their size, color and finish may be varied for identification. For an electronic display with light emitting diodes, the graphics are capable of incorporating different characteristics.

As shown in FIG. 2, an on/off switch 36 and a knob 38 for setting the time are positioned on the back 20 while a quartz movement 40 is positioned within the enclosure 16. The typical quartz movement 40 requires a power source 42 such as a battery. The clock 10 is also capable of receiving power from an external source such as AC voltage supplied through a plug and cord. In this arrangement, the clock 10 incorporates a circuit to convert AC voltage to DC voltage as known in the art.

Referring to the bottom of FIG. 2, the base 22 may include an aperture 44 positioned between an external side 46 and internal side 48 of the enclosure 16. In another embodiment, the aperture 44 may be position on the back 20 between the external side 46 and the internal side 48. The button member 14 may be positioned through the aperture 44 to extend within the internal side 48 and can reciprocate within the aperture 44.

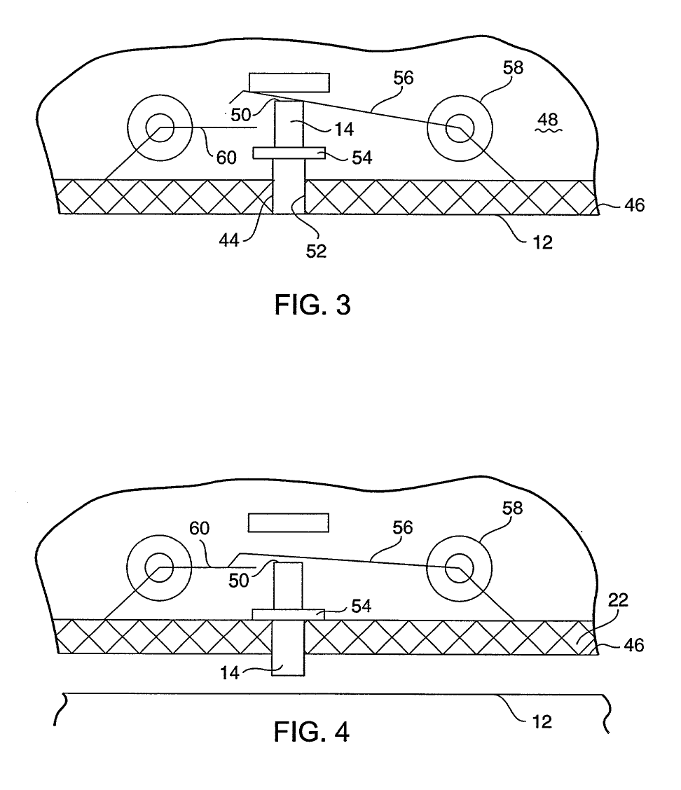

Turning to FIG. 3, the button member 14 is shown in an open position. The button member 14 is typically a “T” shaped member having a button top 50, a button bottom 52 and stops 54. The button member 14 is free to reciprocate within the aperture 44 as will be discussed below. In the position shown in FIG. 3, with the clock 10 resting on the surface 12, the button bottom 52 is flush against the surface 12 due to the gravity pressure of the clock 10 against the surface 12. Accordingly, the stops 54 are pressed upward within the internal side 48 and above the aperture 44.

FIG. 3 further illustrates the button top 50 in contact with at least one movable member 56 wherein the movable member 56 is in further contact with at least one bias member 58. The bias member 58 can include any type of force mechanism, such as but not limited to a spring, a coil, a compression member or a magnetic member. The movable member 56 may extend across the aperture 44 in order to contact the button top 52 in the open position. At least one fixed member 60 is positioned to contact the movable member 56. In the open position, the movable member 56 is not in contact with the fixed member 60. In the embodiment illustrated, the movable member 56 is shown as a pivot member.

Turning to FIG. 4, the external side 46 is shown separated from the surface 12, hence the clock 10 is lifted above the surface 12. Accordingly, the button member 14 is shown in the closed position. Further, the bias member 58 is shown biasing the movable member 56 into contact with the fixed member 60 as will be described below. In this position of FIG. 4, the stops 54 are positioned against the base 22 and the button top 50 is separated from the movable member 56.

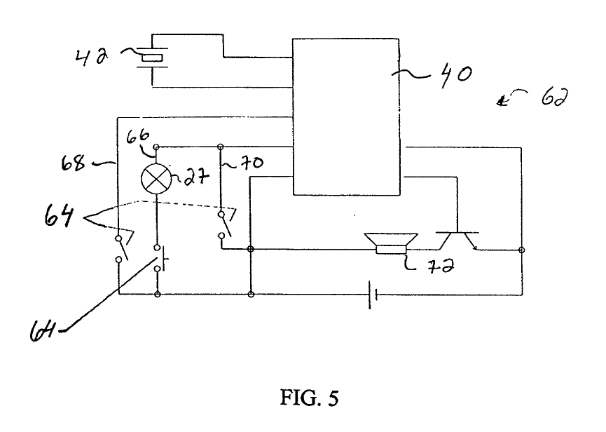

Turning to FIG. 5, a signal circuit 62 is shown wherein the power source 42 supplies the energy to the quartz movement 40. The quartz movement 40, in turn, incorporates circuits having a plurality of switches 64. One switch 64 controls current to a light circuit 66 which incorporates the light source 27. Another switch 64 further controls an alarm circuit 68 while another switch 64 controls a snooze circuit 70. The alarm circuit 68 further includes a speaker 72 as known in the art. For clarity, other common circuits such as timing, programming and audio circuits are not shown. It should be known that the light circuit 66, alarm circuit 68, and snooze circuit 70 may operate independently or simultaneously or in sequence with each other.

Referring to FIGS. 1-5, during use, the user positions the clock 10 on top of the surface 12. The pressure of the clock 10 against the surface 12 pushes the button bottom 52 flush against the surface 12. Accordingly, the button member 14, which is free to reciprocate within the aperture 44, is pressed into an open position of FIG. 3. In this position, the button top 50 extends within the internal side 48 and pushes the movable member 56 to break any contact between the movable member 56 and the fixed member 60.

Referring to FIGS. 1 and 4, when the user picks up the clock 10, the pressure force of the surface 12 is removed. Accordingly, the bias member 58 biases the movable member 56 toward the fixed member 60. Additionally, the biasing of the movable member 56 pushes the button top 50 which in turn pushes the button bottom 52 to extend beyond the plane of base 22. As shown in FIG. 4, the movable member 56 contacts the fixed member 60 while the button top 50 disengages from the movable member 56. The stops 54 then contact the base 22 to prevent the button member 14 from falling out of the clock 10.

When the movable member 56 contacts the fixed member 60 after the pressure of the surface 12 is removed, the signal circuit 62 is closed wherein the movable member 56 and fixed member 60 are electrically conductive. Accordingly, the movement of the button member 14 from the open position to the closed position activates the switches 64 to close the signal circuit 62 to send at least one signal. Current then flows through the light circuit 66 to energize the light source 27. Additionally, the current flows through the snooze circuit 70 to activate the snooze function for when the alarm circuit 68 is set. Thus, when the signal circuit 62 is closed, the snooze circuit 70 and the alarm circuit 68 shut off the alarm and begin the snooze function. If the alarm circuit 68 is not set, then the snooze circuit 70 does not activate the snooze function. When the alarm is not set, however, the light circuit 66 still activates the light source 27 when the clock 10 is elevated off the surface 12.

Thus, when the user picks up the clock 10, the light source 27 activates to display the graphics of the dial 26. Further, if the alarm is set, the snooze circuit 70 activates the snooze function when the clock is elevated off the surface 12 to shut off the alarm and set the snooze function. Accordingly, the user can easily and comfortably see the display 26 by lifting the clock 10 without having to search in the dark for a small, specific button. Additionally, the user will not inadvertently hit another button to incorrectly set the time and/or alarm since the user needs only to elevate the clock 10 in the present invention. Further, by lifting the clock 10, the user can in one motion sees the time and set the snooze function. Accordingly, when the alarm activates, the user simply picks up the clock 10 and the alarm is automatically snoozed.

When the user sets the clock 10 back down on to the surface 12, the pressure of the surface 12 pushes the button bottom 52 back into the aperture 12 to the open position. The button top 50 disengages the contact between the movable member 56 and the fixed member 60 by moving the movable member 56 off the fixed member 60. In turn, switches 64 of the signal circuit 62 open preventing current from flowing through the light circuit 66 which deactivates the light source 27. Accordingly, the user can put the clock 10 on the surface 12 and sleep without any bothersome light from the clock 10. Additionally, the user, by putting the clock 10 back on the surface 12, can turn off the alarm and continue sleeping with the snooze function set.

From the foregoing, it will be observed that numerous modifications and variations can be effected without departing from the true spirit and scope of the novel concept of the present invention. It is to be understood that no limitation with respect to the specific apparatus illustrated herein is intended or should be inferred. It is, of course, intended to cover by the appended claims all such modifications as fall within the scope of the claims.

I claim:

1. A clock signal device, comprising:
a fixed member;
a movable member biased to extend beyond the plane of a base; and
a signal circuit connected to the fixed member and movable member to operate at least one of a light, snooze and alarm.

2. The clock signal device of claim 1, wherein the movable member includes a button member which reciprocates to break contact between the movable member and the fixed member to disengage the signal circuit.

3. The clock signal device of claim 1, further comprising a bias member configured to bias the movable member beyond the plane of the base.

4. The clock signal device of claim 1, wherein the signal circuit includes a plurality of switches.

5. The clock signal device of claim 4, wherein the signal circuit includes a light circuit.

6. The clock signal device of claim 4, wherein the signal circuit includes a snooze circuit.

7. The clock signal device of claim 4, wherein the signal circuit includes an alarm circuit.

8. The clock signal device of claim 1, further comprising a light source.

9. The clock signal device of claim 1, wherein the movable member is a pivot.

10. A clock signal device for activating a signal by release of pressure over a period of time, comprising:
a base member having an external side, an internal side and an aperture extending between the external side and the internal side;
a movable member positioned within the internal side and across the aperture;
a fixed member positioned within the internal side;
a bias member connected to the movable member to bias the movable member in contact with the fixed member;
a button member positioned within the aperture wherein the button reciprocates by pressure to break contact between the movable member and the fixed member; and
a signal circuit in communication with the movable member and the fixed member wherein the signal circuit sends at least one signal in response to the contact between the movable member and the fixed member.

11. The clock signal device for activating a signal of claim 10, wherein the signal circuit is configured to send a light source signal in response to the contact between the movable member and the fixed member.

12. The clock signal device for activating a signal of claim 10, wherein the signal circuit is configured to send a snooze signal in response to the contact between the movable member and the fixed member.

13. The clock signal device for activating a signal of claim 10, wherein the button member is configured to reciprocate from a normally open position to a normally closed position.

14. An alarm clock for activating a signal when the alarm clock is elevated off a surface, comprising:
an enclosure having an external side, an internal side and a base, the base being normally in contact with the surface;
a button member extending from the surface to the internal side, the button member being normally in contact with the surface; and
a bias member positioned within the internal side to bias the button member partially out of the enclosure and past the plane of the base when the base is elevated off the surface.

15. The alarm clock of claim 14, further comprising a movable member positioned within the internal side and connected to the bias member.

16. The alarm clock of claim 14, further comprising a fixed member positioned within the internal side.

17. The alarm clock of claim 16, further comprising a signal circuit in communication with the movable member and the fixed member wherein the signal circuit sends at least one signal in response to contact between the movable member and the fixed member.

18. The clock signal device for activating a signal of claim 17, wherein the signal circuit is configured to send a light source signal in response to contact between the movable member and the fixed member.

19. The clock signal device for activating a signal of claim 17, wherein the signal circuit is configured to send a snooze signal in response to contact between the movable member and the fixed member.

20. A method of using an alarm clock which activates at least one signal when the alarm clock is elevated off a surface, comprising:
pressuring a button member in an opened position;
elevating the alarm clock off the surface;
biasing a movable member in contact with a fixed member while biasing the button member to a closed position; and
engaging at least one signal in response to the contact between movable member and the fixed member.

21. The method of using an alarm clock according to claim 20, further comprising lowering the alarm clock back on the surface.

22. The method of using an alarm clock according to claim 20, further comprising pressuring the button member back to the open position.

23. The method of using an alarm clock according to claim 20, further comprising disengaging the at least one signal.

24. The method of using an alarm clock according to claim 20, wherein the at least one signal is a light signal.

25. The method of using an alarm clock according to claim 20, wherein the at least one signal is a snooze function.
